(19) United States
(12) Patent Application Publication
(10) Pub. No.: US 2019/0265511 A1
(43) Pub. Date: Aug. 29, 2019

(54) HINGE FOR A SPECTACLES FRAME COMPRISING AT LEAST ONE INTERNAL END STOP

(71) Applicants: Richard Chene, Neuilly (FR); Dominique Delamour, Les Mesnuls (FR); Alain Miklitarian, Paris (FR)

(72) Inventor: Dominique Delamour, Les Mesnuls (FR)

(21) Appl. No.: 16/307,904

(22) PCT Filed: May 19, 2017
(86) PCT No.: PCT/EP2017/062108

§ 371 Date: Dec. 6, 2018

(30) Foreign Application Priority Data
Jun. 10, 2016 (FR) 1655340

(51) Int. Cl. G02C 5/22

(52) U.S. Cl. CPC G02C 5/2263; G02C 5/2236

(57) ABSTRACT

A hinge for a spectacles frame, comprising a front face element, a side element and a connecting element connecting said front face element to said side element, said connecting element comprising a base member, mounted in the side element, and a head member, housed in a cavity in the front face element so as to allow the side element to be open/closed about a vertical first axis of articulation and so as to allow the side element to be inclined about a horizontal second axis of articulation, the front face element comprises at least one internal end stop member extending into said cavity so as to limit the movement of the side element about the horizontal second axis of articulation.

### TECHNICAL FIELD

The present invention relates to the field of spectacles frames and, more particularly, to that of hinges for spectacles frames.

Conventionally, spectacles are made of a spectacles frame in which lenses are mounted, for protection against the sun, eyesight correction or for novelty and costume purposes. The spectacles frame comprises a front face, also called main frame, configured to receive said lenses, and temples mounted on the side ends of said front face. Each temple is connected to the main frame by means of a hinge, the main purpose of which is to allow the folding/unfolding of the temple.

In this document, the terms horizontal and vertical are defined with respect to a spectacles frame in a position of use, which comprises a front face in a vertical plane and longitudinal temples configured to unfold in a horizontal plane, i.e. orthogonally to said front face according to a vertical axis. In this document, a transversal plane is a plane that is both orthogonal to the horizontal plane and to the vertical plane.

Ordinarily, a hinge comprises a front face element, a side element and a connecting element connecting said front face element to said side element to enable a rotation of the side element with respect to the front face element in a horizontal plane. In other words, each hinge authorises a horizontal rotation to fold/unfold the temples of the spectacles with respect to the front face, between an open and a closed position. Such a rotation is known in the prior art and will not be described in further detail. Furthermore, such a hinge generally allows an over-opening with respect to the conventional open position, which extends its lifespan. The hinge also includes an elastic spring to facilitate the opening/closing of the temple by accelerating the motion of the side element.

Furthermore, in order to increase the lifespan of a spectacles frame, it has been proposed to authorise the rotation of the temples of the spectacles in a transversal plane about a horizontal axis in order to reduce the risk of breakage when handling the temple. The temple of the spectacles can thereby be inclined according to a “breaking” angle.

Patent application FR3023928A1 proposes a hinge for a spectacles frame, comprising a double articulation to allow the temples to open/close in the horizontal plane, while also allowing them to be inclined in the transversal plane. For this purpose, a hinge is proposed comprising a front face element in which is formed an internal cavity to enable the housing of a head member of the connecting element.

To allow a relative movement in the horizontal plane of the side element with respect to the front face element (rotation about a first vertical axis of rotation), the body of the front face element comprises a first guide slot, extending in the horizontal plane, formed in a continuous manner on the two faces of the front face element. Therefore, the connecting element can move from an open position to a closed position of the hinge. Similarly, to allow a relative movement in the transversal plane of the side element with respect to the front face element (rotation about a second horizontal axis of rotation), the front face element comprises a second guide slot, extending in the transversal plane to allow an upwards and a downwards inclination.

The ends of the guide slots form end stops for the side element when the side element is closed/open/over-opened or transversally inclined upwards or downwards. To ensure the robustness of the hinge, the walls of the front face element must be thick to allow the formation of end stops providing sufficient mechanical resistance, despite the presence of the guide slots. If a hinge of small dimensions is required, it is not possible to reduce the thickness of the walls of the front face element 1 without affecting the robustness of the hinge, which is a disadvantage. An immediate solution would be to reduce the length of the guide slots, but this would limit the amplitude of inclination in the horizontal plane and in the transversal plane. The performance of the hinge would therefore be reduced.

The purpose of the invention is therefore to overcome this disadvantage by proposing an elastic hinge, i.e. with an elastic spring, capable of allowing a first rotation according to a horizontal plane and a second rotation according to a transversal plane with elevated amplitudes, while remaining robust and having reduced dimensions.

### SUMMARY

The invention relates to a hinge for a spectacles frame, comprising a front face element, a side element and a connecting element connecting said front face element to said side element, said connecting element comprising a base element, mounted in the side element, and a head element, housed in a cavity of the front face element allowing the opening/closing of the side element about a first vertical articulation axis, and an inclination of the side element about a second horizontal articulation axis.

The hinge is notable in that the front face element comprises at least one internal end stop member that extends in said cavity so as to limit the movement of the side element about a second horizontal articulation axis.

Therefore, the inclination of the side element is limited internally by the end stop member of the front face element. Advantageously, the side element is no longer stopped by an end of a guide slot of the front face element, which authorises the formation of a front face element featuring a reduced thickness. Advantageously, a small hinge can therefore be manufactured. When the side element is inclined in breaking position, its inclination is limited, in an optimal manner, by the internal end stop member. The hinge thereby obtained is robust.

Furthermore, as the internal end stop member extends in the internal cavity, the force applied by the side element on the front face element is reduced, because the lever arm is shorter than in the prior art. The size of the end stop element can be reduced by forming an optimal end stop. Advantageously, an effective hinge is obtained, the hinge being able to be inclined according to both articulation axes and featuring increased robustness.

Preferably, the front face element comprises at least two internal end stop members so as to define a given amplitude of movement about the second articulation axis. The use of two end stop members enables to restrict the motion of the side element about an articulation axis in order to prevent unwanted excessive movements.

In a preferred embodiment, the internal end stop members are symmetrical to authorise an angular displacement centred on a central resting position, namely the open position of the hinge.

According to a preferred aspect, the internal end stop member extends to an end of said internal cavity so as to facilitate the mounting of the connecting element in the front face element.

Advantageously, the front face element comprises means to close said internal cavity, the internal end stop member belonging to said closing means. Advantageously, the end stop member is mounted removable in the front face element, in particular on the closing means. Advantageously, the internal end stop member can be added after the mounting of the connecting element in the front face element.

In a preferred embodiment, the closing means are in the form of a hood. Such a hood enables, on one hand, to prevent the removal of the connecting element, and on the other hand, to add the internal end stop member.

Preferably, the head member comprises at least one protruding member configured to cooperate with the internal end stop member. Therefore, the movement of the side element is limited directly in the internal cavity by the head member, no additional element being necessary.

Also preferably, the protruding element is configured to cooperate with the internal end stop member on a flat surface. Cooperation on a flat surface provides significant mechanical resistance and guarantees great stability. Furthermore, the wear of such a flat surface is limited.

In a preferred embodiment, the head member comprises two protruding members so as to cooperate with two internal end stop members.

The invention also relates to a spectacles frame comprising a front face and two temples, each temple being connected to said front face by a hinge such as described above.

### BRIEF DESCRIPTION OF THE DRAWINGS

The invention will be better understood upon reading the following description, provided solely as an example, and with reference to the appended figures, in which:

FIG. 1 is a schematic perspective view of spectacles according to the invention;

FIG. 2 is a schematic view of a cross-section along the horizontal plane of a hinge of the spectacles;

FIG. 3 is a schematic side view of an open hinge;

FIG. 4 is a schematic cross-section view of the hinge of FIG. 3;

FIG. 5 is a schematic perspective view of a closed hinge;

FIG. 6 is a schematic side view of the hinge of FIG. 5;

FIG. 7 is a schematic cross-section view of a hinge in an over-opened position; and

FIG. 8 is a schematic perspective view of a hinge in a breaking position;

It should be noted that the figures provide a detailed view of the invention to illustrate its implementation, said figures can naturally also serve to better define the invention as necessary.

### DETAILED DESCRIPTION

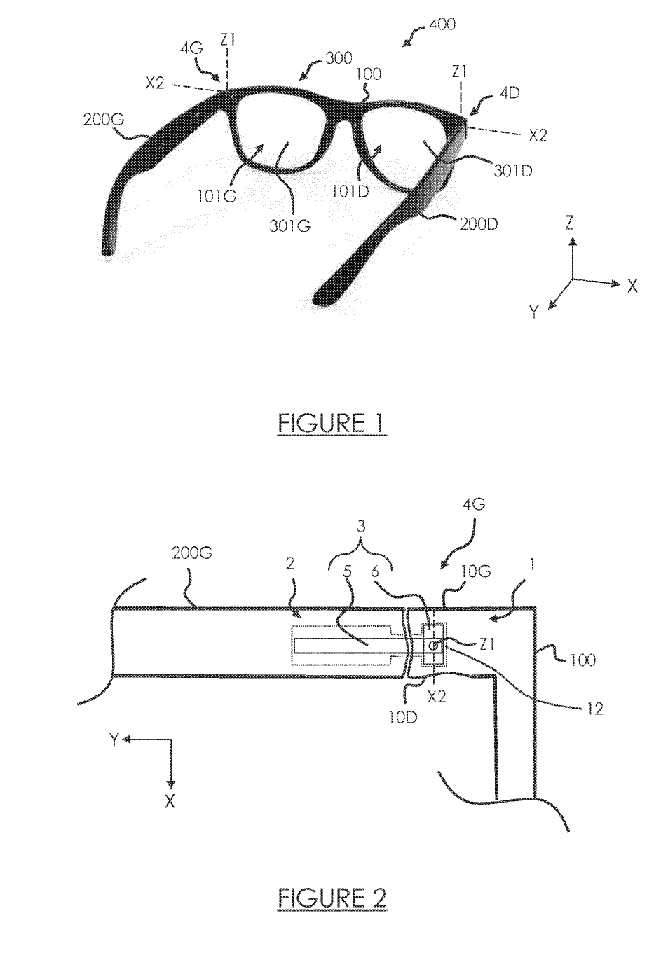

With reference to FIG. 1, spectacles 400 are shown comprising a spectacles frame 300 in which are mounted lenses 301G, 301D.

In this document, with reference in particular to FIG. 1, the spectacles frame 300 is described in an orthogonal system (X, Y, Z) wherein the axis X extends horizontally from left to right, the axis Y extends in depth from the front to the back, and the axis Z extends vertically from bottom to top. In this document, the plane (X, Y) is named horizontal plane, the plane (X, Z) is named vertical plane and the plane (Y, Z) is named transversal plane.

The spectacles frame 300 comprises a front face 100, also called main frame, extending in the vertical plane (X, Z) and comprising a left opening 101G and a right opening 101D to receive respectively a left lens 301G and a right lens 301D.

Still with reference to FIG. 1, the spectacles frame 300 further comprises a left temple 200G and a right temple 200D that are mounted respectively on the left and right side ends of said front face 100 by means of a left hinge 4G and a right hinge 4D. In this implementation example, the hinges 4G, 4D are symmetrical. For purposes of clarity and brevity, only the left hinge 4G is described herein.

As shown in FIG. 2, the left hinge 4G connects the left temple 200G to the left end of the front face 100. According to the invention, the left hinge 4G comprises a front face element 1, a side element 2 and a connecting element 3 connecting said front face element 1 to said side element 2. The term front face element 1 is used to describe an element that forms a part of the front face 100. Said front face element 1 can be a removable/added part of a main part of the front face 100, or be integrated to the front face 100. Similarly, the term side element 2 is used to describe an element that forms a part of the temple 200G. Said side element 2 can be a removable part of a main part of the temple 200G, or be integrated to said temple 200G.

Still with reference to FIG. 2 and as explained below, the hinge 4G allows the side element 2 to be articulated according to a first vertical rotation axis Z1, and a second horizontal rotation axis X2 with respect to the front face element 1 by means of the connecting element 3. Therefore, with reference to FIG. 1, with the first vertical rotation axis Z1, each temple 200G, 200D can move according to a horizontal plane (X, Y) to fold/unfold the temples 200G, 200D. Similarly, with a second horizontal rotation axis X2, each temple 200G, 200D can move in a transversal plane (Y, Z) to absorb impacts and extend the lifespan of the spectacles.

With reference to FIG. 2, the connecting element 3 cooperates, on one hand, with the front face element 1 and, on the other hand, with the side element 2, to allow both rotations Z1, X2, as shown below.

As shown in FIG. 2, the connecting element 3 comprises a base member 5, mounted in the side element 2 and protruding in the front face element 1, and a head member 6 mounted in the front face element 1. The members 5, 6 of the connecting element 3 are presented below in the detailed description of the connecting element 3.

In this document, the term open position of the hinge 4G describes the position of the hinge 4G when the temple 200G is unfolded i.e. aligned with the axis Y. The term closed position of the hinge 4G describes the position of the hinge 4G when the temple 200G is folded, i.e. aligned with the axis X. Similarly, the term breaking position of the hinge 4G describes the position of the hinge 4G when the temple 200G is inclined about the second articulation axis X2.

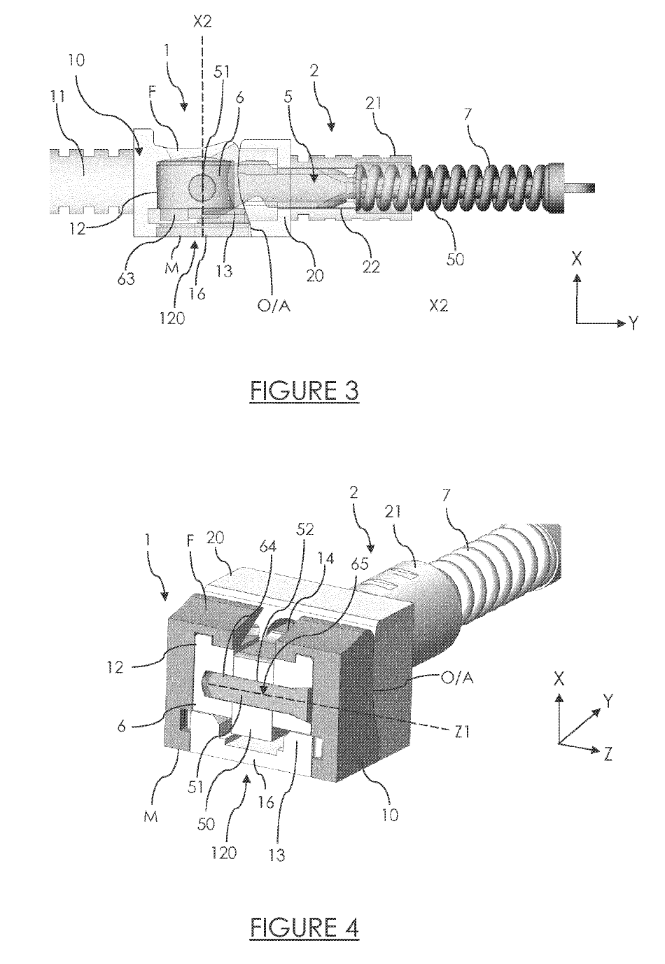

As shown in FIGS. 3 and 4, the front face element 1 comprises a rigid member 10, preferably made of metal, although naturally other materials can be used, such as a metal/plastic alloy for example. The rigid member 10 preferably has a parallelepiped shape, more preferably a cubic shape, defining an opening face O, a closing face F, and mounting face M.

The opening face O of the front face element 1 corresponds with the face in contact with the side element 2 in an open position of the hinge 4G. Similarly, the closing face F of the front face element 1 corresponds with the face in contact with the side element 2 in a closed position of the hinge 4G.

In this example, the opening face O and the closing face F comprise respectively a moving opening surface and a moving closing surface. In a preferred embodiment, each moving surface defines a curved surface such as described in patent application WO2010100087. Similarly, as described below, the side element 2 comprises an active moving surface to cooperate with the moving surface of the opening face O and the closing face F in order to facilitate the opening and closing of the left temple 200G.

Advantageously, the opening face O and the closing face F both comprise elementary contact points distributed at the corners of said faces in order to limit the wear of the hinge 4G during its handling from an open position to a closed position. Naturally, the invention also applies to a front face element 1 that does not feature moving surfaces.

With reference to FIG. 3, the front face element 1 further comprises connection means 11 to a part of the front face 100, which is in the form of a pin. Nonetheless, said connection means 11 could naturally be in another form, such as a tab for example.

With reference to FIG. 3, the body 10 comprises and internal cavity 12 accessible through a mounting opening 120 formed on the mounting face M of said body 10 to allow the housing of the head member 6. In a preferred embodiment, the mounting face M faces the closing face F. In this embodiment, the internal cavity 12 has a cylindrical shape and the mounting opening 120 is circular so as to allow the passage of the cylindrical head member 6. In a preferred embodiment, the mounting opening 120 is closed by closing means after mounting the head member 6. In this example, the closing means are in a form of a hood 16 mounted in a slide, but it goes without saying that it could feature a different shape and be mounted in a different manner.

In this example, with reference to FIG. 4, the internal cavity 12 comprises an internal guide surface configured to allow the guiding of the head member 6. Preferably, the guide surface is in the form of a cylindrical surface with a circular cross- section. Naturally, the guide surface could be discontinuous and comprise a plurality of elementary guide surfaces.

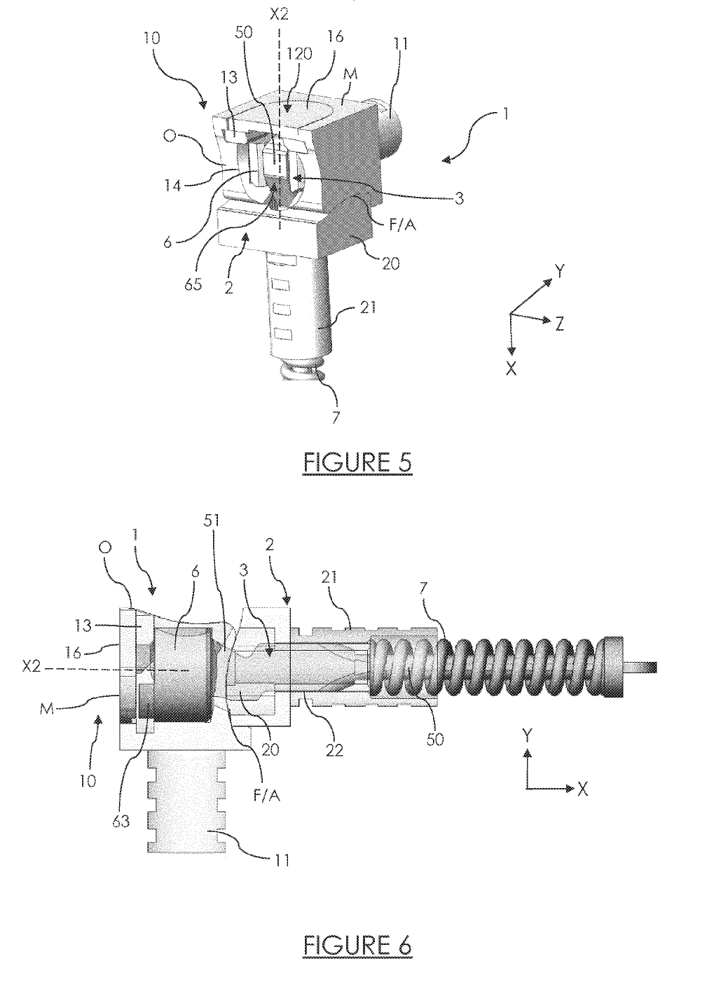

Now with reference to FIGS. 4 and 5, to allow, on one hand, a relative movement in the horizontal plane (X, Y) of the side element 2 with respect to the front face element 1 (rotation about the first axis of rotation Z1) and, on the other hand a relative movement in the transversal plane (Y, Z) of the side element 2 with respect to the front face element 1 (rotation about the second axis of rotation X2), the body 10 of the front face element 1 comprises a guide slot 14 that is formed in a continuous manner in the opening face O and in the closing face F. The portion of the guide slot 14, formed in the opening face O, is widened so as to allow a relative movement in the transversal plane (Y, Z). This embodiment does not comprise two guide slots as in the prior art, but only a widened portion, which facilitates the manufacturing of the front face element 1 and increases its robustness. Preferably, the sides of the guide slot 14 are tapered to improve guiding. The walls, belonging to the body 10 of the front face element 1 and delimiting the guide slot 14, can feature a reduced thickness as is presented below, since they do not form end stops for the connecting element 3.

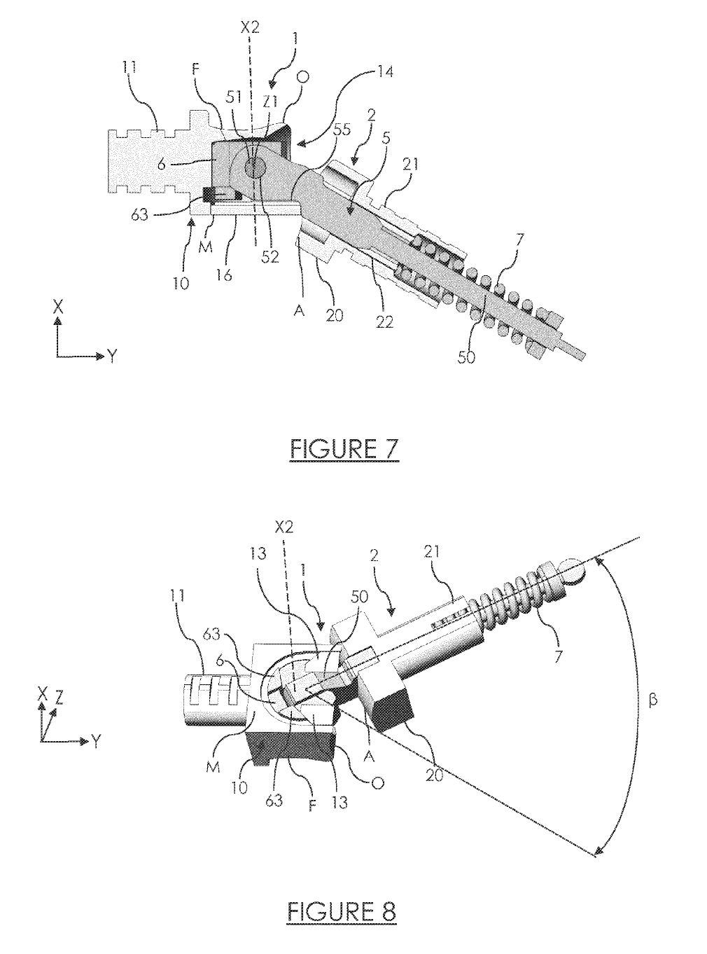

Preferably, the guide slot 14 extends on the entire horizontal length of the opening face O to enable the over-opening of the temple 200G, i.e. a rotation of the left temple 200G about a first axis of rotation Z1 in the opposite direction of the right temple 200D as shown in FIG. 7.

The opening section of the guide slot 14 is smaller than the mounting opening section 120 so that the closing face F forms a stop wall during the insertion of the head member 6, as described below.

This front face element 1 is easy to manufacture by machining since it does not comprise complex shapes, which is advantageous.

As shown in FIGS. 3 and 4, the side element 2 comprises a rigid member 20, preferably made of metal, although naturally other materials can be used, such as a metal/plastic alloy for example.

The rigid member 20 preferably has a globally parallelepiped shape defining a front face A, a rear face and side faces. The front face A, referred to herein as active face A, extends substantially in the vertical plane (X, Z) in an open position of the hinge. As mentioned above, the active face A of the side element 2 features an active moving surface to cooperate with the moving surfaces of the opening O and closing F faces of the front face element, depending on the opening or closing of the hinge. The active moving surface of the side element 2 is shaped to fit with the moving surfaces of the front face element 1.

The side element 2 further comprises the connecting means 21 to a part of the temple 200G which is in the form, with reference to FIG. 7, of a pin formed from the rear face of the rigid body 20. However, said connecting means 21 could naturally be in another form, such as a tab for example. Advantageously, said connecting means 21 also define a bearing surface of the elastic spring 7, as is described below.

Still with reference to FIG. 7, the rigid member 20 of the side element 2 also comprises a traversing opening 22 that extends substantially perpendicular to the active face A, i.e. along the deep axis Y when the hinge 4G is open. The opening 22 also traverses the connecting means 21. The side element 2 can therefore house and guide the base member 5 of the connecting element 3 in its opening 22 as is described below. Preferably, the base member 5 of the connecting element 3 can move along the axis of the opening 22.

In this example, the section of the traversing opening 22 is configured to prevent a rotation of the base member 5 of the connecting element 3 with respect to the side element 2 about the axis of the opening 22. The section of the traversing opening 22 is rectangular in this case but naturally it could be different. Preferably, the section of the traversing opening 22 is smaller at the level of the connecting means 21 than at the level of the front face A of the rigid body 20.

This side element 2 is easy to manufacture by machining since it does not comprise complex shapes, which is advantageous.

The connecting element 3, as shown in FIG. 2, comprises a base member 5 and a head member 6, which are articulated together about a first articulation axis Z1. For this purpose, the head member 6 extends horizontally along the axis X, whereas the base member 5 extends along the axis Y in an open position.

The connecting element 3 is made of metal in order to feature significant mechanical resistance and a low wear rate. However, the connecting element 3 could naturally be made of other materials, such as a metal/plastic alloy.

With reference to FIGS. 3 and 4, the base member comprises a longitudinal stem 50 connected to a connecting bar 51 that extends vertically along the first articulation axis Z1. In this embodiment example, with reference to FIG. 8, the longitudinal stem 50 and the connecting bar 51 of the base member 5 are independent, but naturally they could form a single forged unit.

With reference to FIG. 3, the longitudinal stem 50 comprises a front section configured to protrude in the front face element 1 and a rear section adapted to be guided in the side element 2.

The front section of the longitudinal stem 50 has a front end with an annular form in which is formed a traversing opening 52 along the axis Z1 (FIG. 4). The connecting bar 51 is configured to cooperate in the traversing opening in order to form an articulation along the vertical axis Z1. The longitudinal stem 50 comprises a mounting portion featuring a section with a shape that fits with the traversing opening 22 of the side element 2. In this example, the mounting portion comprises a rectangular section. The rear part of the longitudinal stem 50 has a section that is smaller than the section of the front part so that the rear part remains abutted in the side element 2.

Still with reference to FIG. 3, the rear part of the longitudinal stem 50 has an annular section so that it can be inserted in an elastic spring 7, preferably a compression spring. In a preferred embodiment, the elastic spring 7 is crimped at one end so as to constrain the elastic spring 7. However, other constraining means could naturally be used. In particular, the rear part of the longitudinal stem 50 could comprise a threaded portion to enable a nut to be screwed between the front part of the longitudinal stem 50 and said nut in order to adjust the tension of the elastic spring 7. The use of such an elastic spring 7 is known by the person skilled in the art and will not be presented in further detail.

With reference to FIG. 4, the connecting bar 51 housed in the traversing opening 52 of the longitudinal stem 50 projects on either side of said opening 52 along the vertical axis Z1 in order to cooperate with the head member 6, as is shown below.

With reference to FIG. 7, the base member 5 further comprises a notch 55 configured to abut against the front face element 1 and thereby limit the over-opening about the articulation axis Z1.

With reference to FIG. 4, the head member 6 is in the form of a single-block cylindrical part comprising a mounting groove 65 for the passage of the front part of the longitudinal stem 50 and an opening 64 for the passage of the connecting bar 51, as shown in FIG. 4. The head member 6 has an outer guide surface that is in the form of a portion of a cylindrical shell with an annular section extending along the second articulation axis X2 in order to cooperate, by complementarity, with the inner guide surface of the internal cavity 12 of the front face element 1.

The head member 6 comprises a mounting groove 65 defining a housing, delimited by two flat surfaces, wherein the longitudinal stem 50 is mounted.

As described previously, the head member 6 further comprises a traversing opening 64 to cooperate with each of the two ends of the connecting bar 51 projecting on either side of the longitudinal stem 50. The traversing opening 64 extends orthogonally to the flat surface of the mounting groove 65. In this embodiment, the opening 64 is blind and doesn't traverse the head member, which facilitates assembly. In an assembled position, the opening 64 of the head member 6 is aligned with the opening 52 of the base member 5 in order to allow the assembly of the connecting bar.

The base member 5 is therefore articulated around the first articulation axis Z1 with respect to the head member 6 by means of the connecting bar 51, so as to allow the base member 5 to rotate with respect to the head member 6 in the horizontal plane (X, Y). The temple can therefore move between opening, closing and over- opening positions.

Similarly, the connecting element 3 is articulated about a second articulation axis X2 with respect to the front face element 1 so as to enable the connecting element 3 to rotate with respect to the front face element 1 in the transversal plane (Y, Z). The temple can therefore move between upper and lower breaking positions.

The outer guide surface of the head member 6 has a diameter that is smaller than that of the inner cavity 12, of approximately 1 to 2 mm, in order to create a clearance during the assembly while allowing optimal guiding.

According to the invention, the front face element 1 further comprises two internal end stop members 13 that extend in said internal cavity 12 of the front face element 1 so as to limit the movement of the side element 2 about the axis of rotation X2, i.e. to limit the breaking angle of the temple. These internal end stop members 13 enable to define an angular range of movement β about the second articulation axis X2.

As shown in FIG. 8, the internal end stop members 13 are symmetrical so that the angular range of movement is centred on the open position of the temple, i.e. when the side element 2 extends orthogonally to the front face 100.

In order to cooperate with the internal end stop members 13 of the front face element 1, the head member 6 comprises two protruding members 63 configured to limit the relative movement between the connecting element 3 and the front face element 1. Naturally, the number of internal end stop members 13 and protruding members 63 can change according to the needs.

Still with reference to FIG. 8, the internal end stop members 13 belong to the closing hood 16 and extend to one end of said internal cavity 12, in the vicinity of the mounting face M. In this example, the protruding members 63 extend to one end of the head member 6 so as to come into contact with the internal end stop members 13 based on the inclination of the side element 2 around the second horizontal articulation axis X2.

Preferably, each protruding member 63 is configured to cooperate with an internal end stop member 13 on a flat surface to enable a robust and firm stop, which improves the solidity of the hinge and enables its miniaturisation. The assembly of a hinge is now described. In this example, the connecting element 3 has been preassembled. Firstly, the longitudinal stem 50 of the base member 5 is inserted successively in the opening of the mounting face M of the front face element 1 and then in the traversing opening 22 of the side element 2 so that the connecting element 3 is in the side element 2.

Upon insertion, the longitudinal stem 50 is guided by the guide slot 14 of the front face element 1. Because of the section difference, the front part of the longitudinal stem 50 abuts against the side element 2 and remains protruding with respect to said side element 2.

Then, the head member 6 of the connecting element 3 is introduced by the mounting face M of the front face element 1 to be housed in the internal cavity 12 and abut against the closing face F. The protruding members 63 then extend to the vicinity of the mounting face M. Then the opening 120 of the mounting face M is closed by the addition of the closing hood 16. Any unwanted movement of the head member 6 is thereby eliminated. Furthermore, as the closing hood 16 comprises internal end stop members 13, the movements of the head member 6 are directly limited during the installation of the closing hood 16.

The active face A of the side element 2 then comes to bear against the opening face O of the front face element 1 so that their moving surfaces cooperate. The tension of the elastic spring 7 that maintains the contact of the front face element 1 against the side element 2 is then adjusted by crimping. In the open position, the longitudinal stem 50 extends in the centre of the guide slot 14 of the opening face O.

The assembly of such a hinge is a simple process, which represents a time saving and a reduction of the cost price of the frame formed with said hinges.

As shown in FIG. 3, representing the open hinge seen from the side, the active moving surface of the side element 2 is in contact with the opening moving surface of the front face element 1.

To fold the temple, a user moves the temple towards the front face. With the articulation between the base member 5 and the head member 6, the connecting element 3 can turn in the internal cavity 12 of the front face element 1 about the articulation axis Z1. During this rotation, the base element 5 moves in the guide slot 14, in particular in the opening face O and the closing face F. As shown in FIG. 5, the connecting bar 51 enables to guide the rotation of the temple. In a closed position, with reference to FIGS. 5 and 6, the temple extends along the axis X in a horizontal plane (X, Y) and the active moving surface of the element of the temple 2 is in contact with the moving surface of the closing face F of the front face element 1. During closing, the internal end stop members 13 are not used.

Furthermore as the guide slot 14 of the front face element 1 extends on the entire horizontal length of the opening face O. the temple can move to an over-open position as shown in FIG. 7. The temple can therefore move in the horizontal plane (X, Y) in an angular range of −45 to +90° with respect to its reference open position. Similarly, during over-opening, the internal end stop members 13 are not used. The slot 55 of the base member 5 comes into contact with the front face element 1.

The inclination of the temple in a breaking position is now presented. Starting from the open position of the hinge, the active face A of the side element 2 is in contact with the opening face O of the front face element 1.

With reference to FIG. 8, the user moves the temple vertically upwards in a transversal plane (Y, Z). The head member 6 rotates about its axis in the internal cavity 12 when the side element 2 is moved around the articulation axis X2 until a protruding member 63 of the head member 6 abuts with an internal end stop member 13. Therefore, during the rotation, the base member 5 moves in the guide slot 14 of the front face element 1, in particular in the opening face. Since the guide slot 14 is widened in the opening face O, the temple can be inclined upwards and downwards.

The temple can therefore move in the transversal plane (X, Y) in an angular range β of −45 to +45° with respect to its reference open position. This annular range β can advantageously be adjusted based on the position of the internal end stop members 13 and the protruding members 63.

As the sides of the guide slot 14 are curved, the temple can be moved in directions comprising a component along the first axis of articulation Z1 and a component according to the second axis of articulation X2 to provide flexibility to the hinge and improved resistance in its open position.

Furthermore, because of the elastic spring 7 and the nature of the connecting element 3, the hinge 4G is returned automatically to a centred opening position when the user is no longer acting on the temple.

Advantageously, during the rotation of the side element 2 about the articulation axis X2 in opening position, the periphery of the guide slot 14 is not used and can have a reduced thickness. A high performance miniature hinge can therefore be obtained.

With the hinges according to the invention, the spectacles frame 300 is more resistant and can withstand various handling operations without being damaged (folding, unfolding, over-opening, transversal movements, etc.) while featuring a simple structure that can be miniaturised with few constraints. Furthermore, its cost price is reduced with respect to the prior art, given the manufacturing simplicity of the connecting element 3 and its ease of assembly. Finally, such a hinge is integrated to the frame, i.e. it is not visible to the end user, which is an aesthetic advantage.

1. Hinge for a spectacles frame, comprising a front face element, a side element and a connecting element connecting said front face element to said side element, said connecting element comprising a base member, mounted in the side element, and a head member, housed in a cavity of the front face element to allow an opening/closing of the side element about a first vertical articulation axis and an inclination of the side element about a second horizontal articulation axis, the head member comprising an outer guide surface in the form of a portion of a cylindrical shell with an annular section extending along the second articulation axis to cooperate, by complementarity, with the inner guide surface of the cavity of the front face element, hinge characterised in that the front face element comprises at least one internal end stop member that extends in said cavity so as to limit the movement of the side element about the second horizontal articulation axis.

2. Hinge according to claim 1, wherein the front face element comprises at least two internal end stop members so as to define a given amplitude of movement about the second articulation axis.

3. Hinge according to claim 2, wherein the internal end stop members are symmetrical.

4. Hinge according to one of the claim 1, wherein the internal end stop member extends to an end of said internal cavity.

5. Hinge according to claim 1, wherein the front face element comprises means to close said internal cavity, the internal end stop member belonging to said closing means.

6. Hinge according to claim 1, wherein the head member comprises at least one protruding member configured to cooperate with the internal end stop member.

7. Hinge according to claim 6, wherein the protruding element is configured to cooperate with the internal end stop member on a flat surface.

8. Hinge according to claim 6, wherein the head member comprises at least two symmetrical protruding members.

9. Hinge according to claim 1, wherein the internal end stop member is mounted removable.

10. Spectacles frame comprising a front face, two temples, each temple being connected to said front face by means of a hinge according to claim 1.
